(19) United States
(12) Patent Application Publication
(10) Pub. No.: US 2008/0162159 A1
(43) Pub. Date: Jul. 3, 2008

(54) COMPONENT TO SUPPORT PREPAID DEVICES

(76) Inventors: Zhou Wang, Shanghai (CN); Kogan Dan, Hillsboro, OR (US); Han Ying Chen, Shanghai (CN); Zhongmin Wu, Shanghai (CN)

Correspondence Address: Ling Hong;Blakely, Sokoloff, Taylor & Zafman LLP, Seventh Floor, 12400 Wilshire Boulevard, Los Angeles, CA, 90025-1030, US

(21) Appl. No.: 11/618,491

(22) Filed: Dec. 29, 2006

(51) Int. Cl. G06Q 99/00

(52) U.S. Cl. 705/1

(57) ABSTRACT

A computing system comprises a motherboard. The computing system further comprises a processor and a control module that couples to the processor to initiate a lock mode based on a usage policy associated with lock mode and in response to detecting an event associated with a payment for the system.

### BACKGROUND

Some prepaid computing devices may depend on software such as operating systems to perform payment validation. In response to determining that the payment is invalid and/or a grace period of the payment expires, the operating systems can suspend its bootable process so as to realize locking of the computing devices.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of an apparatus that may enable a prepaid PC usage.

FIG. 2 illustrates an embodiment of system states of a computing system.

FIG. 3 illustrates an embodiment of a computing system.

FIG. 4 illustrates another embodiment of a computing system.

FIG. 5 illustrates an embodiment of operation of the computing system of FIG. 3.

### DETAILED DESCRIPTION

The following description describes techniques to support a prepaid computing device. The implementation of the techniques is not restricted in computing device; it may be used by any execution environments for similar purposes. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. However, the invention may be practiced without such specific details. In other instances, control structures and full software instruction sequences have not been shown in detail in order not to obscure the invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

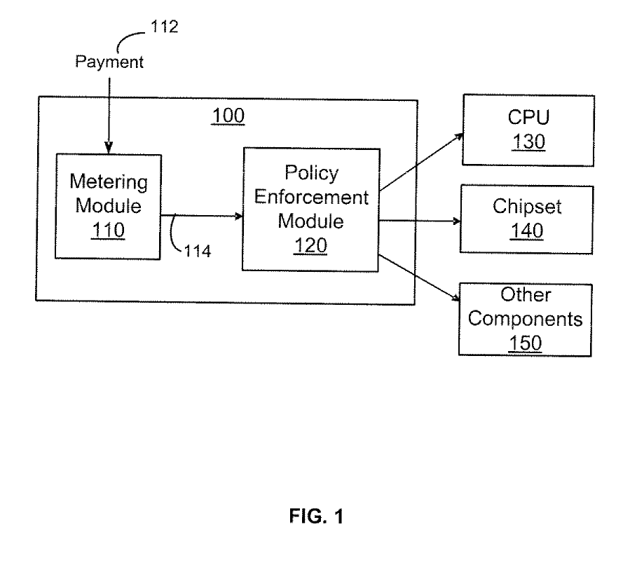

FIG. 1 illustrates an exemplary embodiment of an apparatus 100 that may be used to support a prepaid PC usage model. In one embodiment, the apparatus 100 may comprise a metering module 110. The metering module 110 may be coupled to a policy enforcement module 120 to control operation of a computing system (not shown) or one or more system components in the computing system based on a usage policy that may define a lock mode. Examples of the system components may comprise a CPU 130, chipset 140, and/or any other system components associated with the computing system such as hard disk drive.

In one embodiment, a usage policy may be associated with a lock mode of the computing system. In another embodiment, a usage policy may base on a business model such as pay-by-subscription or pay-by-usage-time. The usage policy may provide information on whether, when and/or how to place the computing system in a lock mode such as preventing one or more system components from operating. One or more system components may be prevented from operating to limit or stop access to a prepaid system or a prepaid portion of the system from working such as an application, an operating system, hardware, firmware, software, or driver. For example, a usage policy may comprise information about when to reset CPU 130 of the computing system, in response to an event that payment information associated with the computing system is invalid. In another embodiment, a usage policy may guide the policy enforcement module 120 to prevent the computing system from booting into an operating system or executing software for the computing system in response to determining that a grace period for a payment associated with the computing system expires. In one embodiment, a grace period may be calculated, e.g., by subscription or by usage time or times. In another embodiment, a usage policy may comprise information for the policy enforcement module 120 to select which system component to be prevented from working, in response to detecting an event that the usage times of the system component has exceeded an allowable number associated with a payment.

Referring to FIG. 1, in one embodiment, the metering module 110 may receive payment information 112 of the computing system. For example, the payment information 112 may comprise information on usage fee, service usage fee, network usage fee, subscription fee, or any other fee that is paid associated with the computing system, including a fee for using an application, a fee for using a hardware. The payment information 112 may be inputted to the metering module 110 in any suitable form such as packet, bit, code, or data.

In one embodiment, the metering module 110 may execute codes e.g., running a software that may be stored in a firmware to validate the payment information 112 based on one or more metering policies such as. For example, the metering module 110 may convert payment information 112 into an amount of time that the computing system can be used and track an amount of time that the computing system has been used, to determine whether the payment information 112 is valid. In another embodiment, the metering module 110 may convert the payment information 112 into a data value such as an allowable amount of usage of the system and track an amount of usage that the computing system has been used, to validate the payment information 112. In another embodiment, the metering module 110 may communicated with the policy enforcement module 120 to implement a prepaid usage model.

In one embodiment, the payment information 112 may be converted into one or more metering data values 114 such as an amount of time that allow a user to use the computing system or allowable times that the computing system can be used or any other data, parameters based on a metering policy associated with a business model, e.g., pay by subscription, pay by usage time such as a payment based on how much time a system has been used, pay by usage times or count such as a payment based on how many times a system has been used. In one embodiment, a metering policy may provide information on how a payment is measured or how to perform one or more metering functions such as converting payment information into an internal value and track usage of the computing system and/or validate the payment information, etc. The policy enforcement module 120 may decide when to lock the computing system based on a usage policy. In another embodiment, the payment information 112 may be converted by the metering module 110 into a control signal 114 to the policy enforcement module 120 that may lock the computing system based on the control signals. For example, a control signal may be used by the policy enforcement module 120 to assert a logic value to disable or limit one or more system components or the computing system to lock the computing system, or hardware, operating system, software, drive or any part associated with the computing system.

In another embodiment, the metering module 110 may track a payment, e.g., over time. For example, the metering module 110 may, e.g., determine whether usage of the computing system has exceeded a payment; however, in some embodiments, the determination may be made on one or more system components, and/or any hardware, firmware, drive, or software such as an operating system or an application associated with the computing system. The metering module 110 may instruct the policy enforcement module 120 to limit or stop access to the computing system based on one or more usage policies, in response to detecting an event that the usage of the computing system has exceeded the payment. In another embodiment, the metering module 110 may command the policy enforcement module 120 to prevent the computing system from becoming operational, e.g., prevent booting, based on a usage policy.

In another embodiment, the policy enforcement module 120 may implement a metering function based one or more metering policies and lock one or more system components or the computing system. The policy enforcement module 120 may have access to one or more system components, such as the CPU 130, chipset 140, or a subscribed or prepaid hardware, firmware or other components 150. The policy enforcement module 120 may control operation of the system components. In another embodiment, the policy enforcement module 120 may prevent one or more system components or the computing system from reaching a power state, or limit or disable a function of a system component or the computing system, based on a usage policy. In another embodiment, the policy enforcement module 120 may trigger a system component to stop operating, such as entering a lock mode, based on a usage policy.

Referring to FIG. 1, in one embodiment, any suitable processing or control module may be utilized for the metering module 110, such as a microcontroller, a micro control unit (MCU), or a coprocessor such as manageability engine (ME) that may be embedded in the chipset 140 or a motherboard. In one embodiment, the metering module 110 may load codes from a flash or a firmware, or any other storing modules such as a Trusted Platform Module (TPM) to validate payment information of a payment or one or values associated with the payment information, such as tracking a payment over time. In another embodiment, the metering module 110 may be implemented by firmware such as Intel EFI™ technology.

In another embodiment, the metering module 110 may command the policy enforcement module 120 to trigger a level of a lock mode based on one or more usage policies, in response to determining an event associated with the payment, such as an event that no payment or no credit is present. In another embodiment, the metering module 120 may instruct the policy enforcement module 120 to lock the computing system or one or more system components based on a usage policy, in response to determining that a grace period associated with a payment expires. The metering module 110 may communicate with the policy enforcement module 120 to implement a lock mode such as hardware lock mode. In another embodiment, the policy enforcement module 120 may receive one or more control signals 114 from the metering module 110 and initiate a lock mode, such as CPU reset, hard disk drive lock and/or computing system shutdown, e.g., by a logic value, in response to the control signals. While control signals may be utilized, in some embodiments, other control information such as instructions, commands, files, applications or data may be utilized.

In another embodiment, one or more functions of the metering module 110 may be implemented in the policy enforcement module 120. In one embodiment, the metering module 110 may convert the payment information into one or more internal values 114 such as metering data values, e.g., an amount of time that the computing system can be used, or a value corresponding to a business model such as pay-by-subscription or pay-by-usage-time or any other parameters. In some embodiments, any suitable values associated with the payment may be utilized, such as how long the system can be used or an allowable usage period, how many times the system can be used or a number for the allowable usage times, or a value corresponding to a part of the system that can be used for the payment. The policy enforcement module 120 may base on one or more internal values 114 to determine whether, when or how to implement a lock mode based on a usage policy and produce a logic value to trigger a level of a lock mode.

In one embodiment, the policy enforcement module 120 may track, e.g., the amount of time the computing system has executed and/or how many times the computing system or subscribed hardware or software has been used. In another embodiment, the policy enforcement module 120 may track any other values or parameters that may reflect the usage of the computing system or any part of the computing system. In one embodiment, the policy enforcement module 120 may comprise a real time clock such as a trusted clock to measure one or more of the parameters, e.g., how long or how many times the computing system has been used, or count down an allowable usage time of the computing system, or measure a grace period associated with the payment or additional times. A grace period or additional usage times may allow a user to continue using a computing system or any part of the system even if the usage of the system or the part exceeds a payment.

In yet another embodiment, the policy enforcement module 120 may transmit a logic value to a system component or the computing system to limit or stop one or more functions of the computing system, such as turning off the computing system based on a usage policy and in response to determining that a grace period associated with a payment expires or the computing system has been used for more than an allowable number of times and/or a number of additional usage times corresponding to a payment. In another embodiment, the policy enforcement module 120 may decide whether and/or when to implement a lock mode based on a usage policy, even if the grace period of a payment expires.

In another embodiment, the policy enforcement module 120 may assert a logic value or any other signals such as function limitation levels to trigger a lock mode. In one embodiment, the policy enforcement module 120 may be implemented on the motherboard or the chipset. In another embodiment, any processing or control module may be utilized for the policy enforcement module 120, such as a firmware, or circuit.

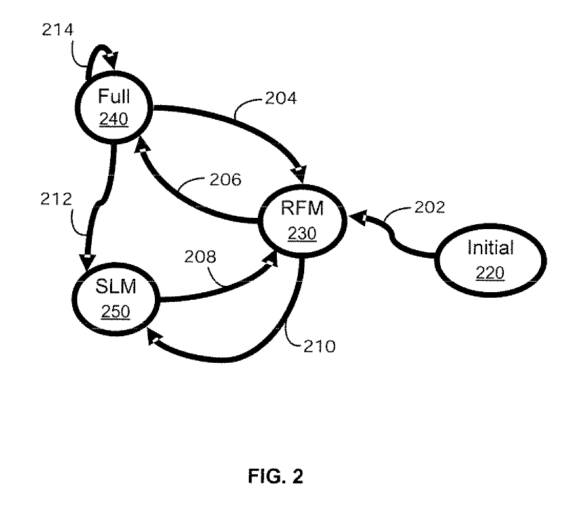

FIG. 2 illustrates an embodiment of system states of a computer system. Referring to FIG. 2, in one embodiment, the computing system may have an initial mode 200. The computing system may further comprise a reduced function mode (RFM) 230. For example, under RFM 230, a CPU of the computing system may operate under a first frequency. In another embodiment, the computing system may boot into any operating system such as Windows. As shown in FIG. 2, the computing system may comprise a full mode 240. In the full mode 240, the CPU of the computing system may operate under a second frequency, wherein the second frequency may be larger than the first frequency. In the full mode 240, the computing system may operate. The computing system may further comprise a lock mode 250. The policy enforcement module 120 of FIG. 1 may assert a logic value to trigger the lock mode 250, e.g., preventing one or more system components of the computing system such as CPU or the computing system from operating. For example, the computing system may be locked during the lock mode 250.

Referring to FIG. 2, the computer system may be initialized (202) to transition from the initial mode 220 to RFM 230. Under RFM 230, e.g., the metering module 110 or policy enforcement module 120 of FIG. 1 may determine whether an internal value 114 such as a metering data value of FIG. 1 is valid to perform a validation on the internal value 114. The computing system may enter the full mode 240, in response to the metering module 110 or the policy enforcement module 120 detecting an event that the internal value 114 is valid or the amount of time that the computing system can be used has not expired (206). In another embodiment, a periodic or regular validation or determination on the payment information may be performed (214) in the full mode 240. In response to determining in the full mode 240 that the internal values 114 are invalid or the computing system is used in a grace period (204), etc., the computing system may be transferred from the full mode 240 to RFM 230.

In another embodiment, in RFM 230, the metering module 110 or the policy enforcement module 120 may further perform a determination on whether the grace period expires. In response to determining that the grace period expires and the policy enforcement module 120 asserting a logic value that may instruct to lock the computing system and/or one or more system components (210) in the RFM 230, the computing system may enter the lock mode 250. For example, one or more system components and/or the computing system may be locked or be inoperative in the lock mode 250, in response to the expiring of the grace period and the policy enforcement module 120 providing a signal to the component or the system, such as asserting a logic value, e.g., TRUE or FALSE or any suitable function limitation levels.

In another embodiment, the computing system may transition from the lock mode 250 back to RFM 230, in response to determining that a payment regarding the lock mode has been completed (208). For example, a user of the computing system may obtain an unlock code to unlock the computing system, in response to the user paying corresponding fee. In another embodiment, any other files, signals or data may be utilized to show the payment has completed. In another embodiment, the computing system may transition from the full mode 240 to the lock mode 250, in response to an event that an unauthorized using of the computing system is detected (212).

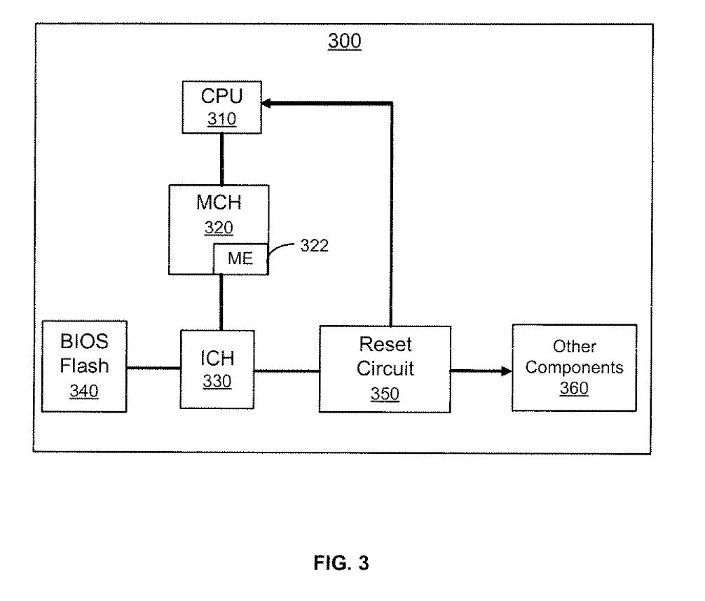

FIG. 3 illustrates an embodiment of a computing system 300. In one embodiment, the computing system 300 may comprise CPU 310 that may couples to Memory Controller Hub (MCH) 320. In one embodiment, MCH 320 may control one or more memory devices (not shown) in the computing system 300, such as reading data from the memory devices and/or write data to the memory devices. While FIG. 3 illustrates to utilize MCH 320, in another embodiment, any other memory controller may be utilized. In one embodiment, MCH 320 may be coupled to I/O Controller Hub (ICH) 330; however, in some embodiments, one or more other input/output controlling devices may be utilized.

Referring to FIG. 3, ICH 330 may couple with Basic Input/Output system (BIOS) flash 340 to store BIOS code or data; however, in some embodiment, other memory devices may be utilized, such as non-volatile memory devices, e.g., read-only memory (ROM) devices, flash memory, or any other memory devices or BIOS devices. The BIOS flash 340 may be used to store codes or data that may be used by a manageability engine 322 to perform one or more functions of the metering module 110 and/or the policy enforcement module 120 of FIG. 1. In another embodiment, any other firmware, firmware software, hardware or hard disc drive may be utilized to store the payment information.

As shown in FIG. 3, in one embodiment, MCH 320 may comprise a manageability engine 322. The manageability engine 322 may perform one or more functions of the metering module 110 and/or the policy enforcement module 120 of FIG. 1. In another embodiment, the manageability engine 322 may comprise the metering module 110 of FIG. 1. For example, manageability engine 322 may run BIOS codes, e.g., from the BIOS flash 340 to validate payment information associated with a payment. During the validation, the manageability engine 322 may convert payment information into metering data values 114 such as an amount of time that the computing system 300 can be used. In another embodiment, during the validation, the manageability engine 322 may further track how long the computing system 300 has been used and/or decide whether the usage time of the computing system 300 exceeds allowable usage time corresponding to the payment.

In yet another embodiment, the manageability engine 322 may determine that the payment information is invalid, in response to detecting that the usage time of the computing system 300 exceeds the allowable usage time. The manageability engine 322 may further determine whether a grace period associated with the payment expires. The manageability engine 322 may provide one or more control signals to the reset circuit 350, in response to detecting that the grace period expires. The reset circuit 350 may decide whether, when or how to limit one or more functions of the computing system 300 based a usage policy. While FIG. 1 utilizes the manageability engine 322, in some embodiments, any other control modules embedded on a motherboard or a chipset of the computing system 300 may be utilized, such as firmware, or hardware.

The control signals may be communicated to the reset circuit 350 via the ICH 330. In one embodiment, the reset circuit 350 may be used to assert a logic value that may reset CPU 310 and/or one or more other components in the computing system 300, in response to deciding to perform the resetting and in response to expiring of the grace period. In another embodiment, the reset circuit 350 may assert a logic value that may prevent CPU 310, one or more other components, or the computing system 300 from operating. In one embodiment, the reset circuit 350 may comprise the policy enforcement module 120 of FIG. 1. In another embodiment, any other control modules such as hardware, firmware or firmware software may be utilized for the reset circuit 350.

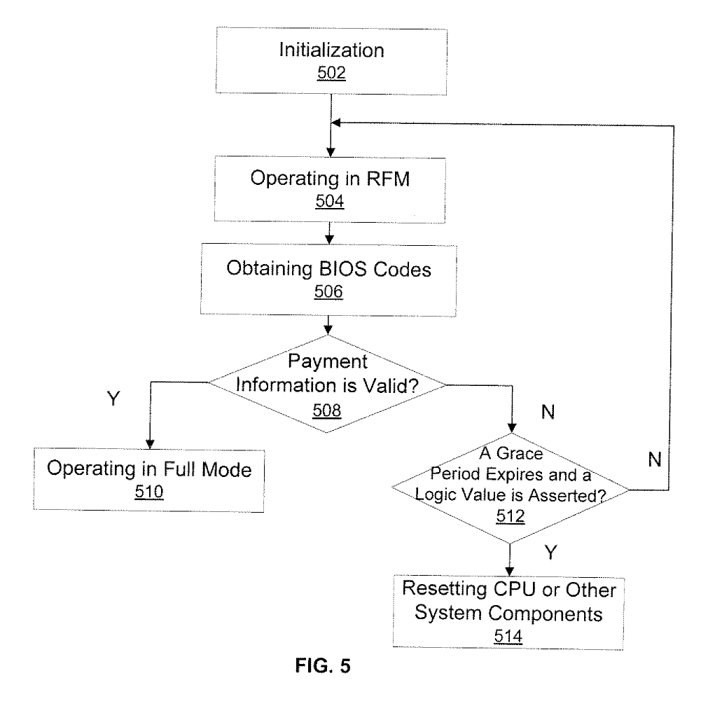

FIG. 5 illustrates an embodiment of a method that may support a prepaid usage model in the computing system 300 of FIG. 3. In block 502, the computing system 300 may be initialized. In block 504, the computing system 300 may be operated in a restrict function mode (RFM). For example, the computing system 300 may boot into an operating system. In block 506, the manageability engine 322 may load, e.g., BIOS codes from the BIOS flash 340 (or any other flash memory or firmware) into a non-volatile memory device (not shown) of the computing system 300. For example, the BIOS codes may be transmitted to the manageability engine 322. In block 508, the manageability engine 322 may run the BIOS codes to validate payment information associated with a payment for the computing system 300. For example, in order for the validation, the manageability engine 322 may download the payment information transmitted from a server (not shown) that couples to the computing system 300; however, in some embodiments, the manageability engine 322 may cooperate with any suitable software to download the payment information.

In another embodiment, the manageability engine 322 may convert the payment information into internal values 114 such as metering data values, including an amount of time that the computer is allowed to be used based on the payment. The manageability engine 322 may further track how long the computing system 300 has been used. In block 510, the computing system 300 may enter a full mode, in response to the manageability engine 322 determining that the internal values are valid, e.g., the computing system 300 is used in an allowable usage period corresponding to the payment. In block 510, if the computing system 300 is not used in the allowable usage period, the manageability engine 322 may determine that the payment information is invalid.

In block 512, the manageability engine 322 may determine whether a grace period for the payment expires. The manageability engine 322 may further determine whether or when to initiate, e.g., a lock mode based on a usage policy. In response to the manageability engine 322 having detected that the grace period expires, and the manageability engine 322 deciding to initiate the lock mode or having determined the time for the initiating, the manageability engine 322 may communicate a command to the reset circuit 350. In block 514, the reset circuit 350 may implement the command to initiate the lock mode, e.g., asserting a logic value in response to the command. The logic value may reset CPU or a system component to lock the computing system 300.

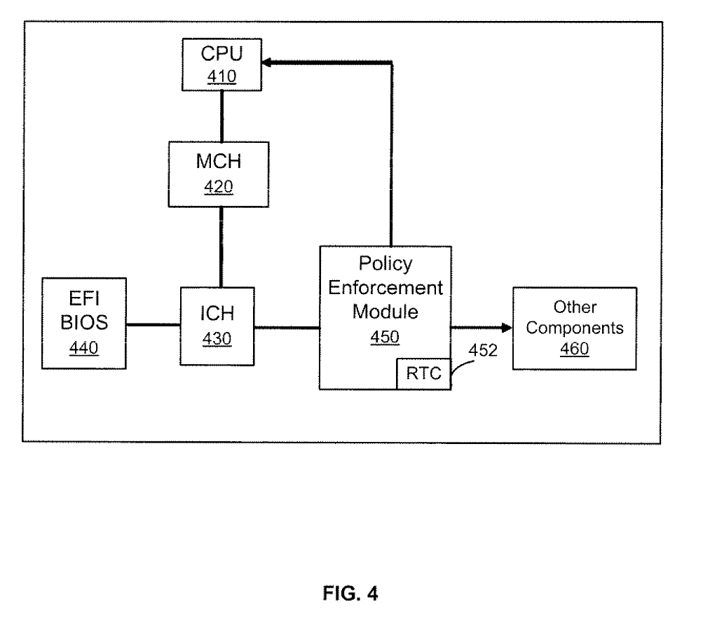

FIG. 4 illustrates another embodiment of a computing system 400. In one embodiment, the computing system 400 may be similar to the computing system 300 of FIG. 3. For example, the computing system 400 may comprise CPU 410, MCH 420, ICH 430. Referring to FIG. 4, in one embodiment, the computing system 400 may further comprise an extensible firmware interface (EFI) BIOS 440 that may couple with ICH 430. The EFI BIOS 440 may run codes stored therein to convert payment information into one or more metering data values such as an amount of time that the computing system 400 is allowed to be used or allowable usage period. In one embodiment, the EFI BIOS 440 may comprise the metering module 110 of FIG. 1 to convert the payment information. While FIG. 4 illustrates to utilize the EF BIOS, any other control module may be utilized, such as firmware, firmware software, or hardware.

Referring to FIG. 4, the policy enforcement module 450 may receive the allowable usage period from the EFI BIOS 440 via ICH 430. In one embodiment, the policy enforcement module 450 may track usage of the computing system 400 over time. For example, the policy enforcement module 450 may comprise a real time clock 452 such as a trusted clock or RTC or any other suitable clocks. The real time clock 452 may measure how long the computing system has been used or a corresponding relative time, or measure or count down the allowable usage period or a relative time corresponding to the usage period, or measure allowable usage times, actual usage times or additional usage times or relative time corresponding thereto, etc. The policy enforcement module 450 may determine whether the computing system is used in the allowable usage period or the real usage time exceeds additional usage times. The policy enforcement module 450 may further determine whether a grace period associated with the payment expires, if the allowable usage period expires. The real time clock 452 may further be used to measure the grace period. The policy enforcement module 450 may further determine whether or when to implement, e.g., a lock mode based on a usage policy. The policy enforcement module 450 may assert a logic value that may limit or stop one or more functions of the computing system 400 or one or more system components, in response to detecting that the grace period expires and determining that the usage policy providing information to limit or stop one or more functions of the computing system 400.

While the method of FIG. 5 is illustrated as a sequence of operations, the illustrated operations may be performed in a different order. In one embodiment, the operations of FIG. 5 may further comprise checking whether a grace period expires in the full mode. A lock mode may be entered in response to determining an event that the grace period has expired and the reset module 350 provides a logic value to lock the system 300. In another embodiment, the operations of FIG. 5 may further comprise checking the validation of the internal values periodically or regularly in the full mode. While FIG. 1 illustrate two modules are utilized to enable or disable usage of a computing system based on a usage policy associated with a payment, one or more control modules may be utilized. The control modules may comprise firmware, circuits and/or codes provided in the firmware.

While the above description may utilize one criterion to validate payment information and/or make lock determinations, one or more criteria associated with one or more parameters such as time or times may be utilized. For example, payment information may be converted into one or more values, such as allowable time (real time or relative time), allowable times, additional allowable usage time or times, or any allowable amount of usage or additional allowable amount of usage. In another embodiment, any other amount of usage may be tracked, such as usage time, or usage times. In another embodiment, how long the system has been used, times, how many times a computing system has been used, may be utilized. While a prepaid computing system may be utilized, in some embodiments, the present invention may be applied to any other prepaid or subscribed system or device, a prepaid portion of the system or device, such as hardware, software, or operating system, etc.

While certain features of the invention have been described with reference to embodiments, the description is not intended to be construed in a limiting sense. Various modifications of the embodiments, as well as other embodiments of the invention, which are apparent to persons skilled in the art to which the invention pertains, are deemed to lie within the spirit and scope of the invention.

What is claimed is:

1. A system comprising:
a processor,
a control module that couples to the processor to initiate a lock mode based on a usage policy associated with the lock mode and in response to detecting an event associated with a payment relating to the system.

2. The system of claim 1, wherein the control module comprises:
a first module to validate payment information associated with the payment to detect the event, and
a second module to limit access to the system in the lock mode based on the usage policy, in response to the first module determining that the payment information is invalid.

3. The system of claim 1, wherein the control module to initiate the lock mode to prevent one or more components of the system from booting into an operating system in the system based on the usage policy.

4. The system of claim 1, wherein the control module to initiate the lock mode to limit one or more functions of one or more components of the system based on the usage policy.

5. The system of claim 1, wherein the control module comprises
a first module to convert payment information associated with the payment into a first value, and
a second module to initiate the lock mode based on the usage policy, in response to detecting the event that the usage of one portion of the system associated with the payment has exceeded the first value.

6. The system of claim 5, wherein the second module to initiate the lock mode based on the usage policy, further in response to detecting that the usage of the portion has exceeded an additional allowable amount of usage associated with the payment.

7. The system of claim 1, wherein the control module comprises
a first module to convert payment information associated with the payment into an allowable usage period, and
a second module to track usage time of a portion of the system, and to initiate the lock mode based on the usage policy, in response to detect the event that the usage time of the portion has exceeded the allowable usage period and a grace period associated with the payment.

8. The system of claim 1, wherein the control module comprises:
a first module to provide a control signal to initiate the lock mode, in response to detecting the event that payment information associated with the payment is invalid, and
a second module to assert a second signal based on the usage policy in response to the control signal to prevent a portion of the system from operating in the lock mode.

9. The system of claim 1, wherein control module comprises:
a first module to validate payment information associated with the payment, wherein the first module is embedded in a motherboard that couples to the system,
a second module to assert a logic value based on the usage policy to prevent the processor from operating in the lock mode, in response to the first module determining that the payment information is invalid.

10. The system of claim 9, wherein the first module comprises one of a group that comprises a microprocessor, a coprocessor, a controller, and a manageability engine.

11. The system of claim 9, wherein the second module comprises a control circuit to reset one or more system components of the system.

12. The system of claim 9, comprising:
a storing module provided on the motherboard, to store a set of codes that are to be used by the first module to validate the payment information.

13. The system of claim 1, wherein the control module comprises:
a firmware to convert payment information associated with the payment into a first value that corresponds to an allowable amount of usage of a portion of the system, and
an enforcement module to track an amount of usage of the portion and to enforce the lock mode based on the usage policy, in response to detecting the event that the amount of usage exceeds the first value and a second value corresponding to an additional allowable amount of usage of the portion.

14. The system of claim 13, wherein the enforcement module comprises a basic input output system.

15. The system of claim 13, comprising:
a clock to measure one or more from a group that comprises the amount of usage, the allowable amount of usage, and the additional allowable amount of usage.

16. A method, comprising:
validating payment information on a payment associated with a system,
limiting one or more functions of a component of the system based on a usage policy that provides information on the limiting, in response to determining that the payment information is invalid.

17. The method of claim 16, comprising:
signaling a control circuit of the system to limit the one or more functions of the component based on the usage policy, in response to determining that a grace period associated with the payment expires.

18. The method of claim 16, wherein validating the payment information comprises:
converting the payment information into a first value based on a metering policy associated with the payment, and
tracking an amount of usage of a portion of the system that relates to the payment.

19. The method of claim 18, comprising:
detecting whether the amount of usage exceeds the first value, and
asserting a logic value based on the usage policy to limit the one or more functions of the component to limit access to the portion, in response to detecting that the usage of the portion exceeds the first value.

20. The method of claim 16, comprising:
converting the payment information into an allowable amount of usage of the portion,
tracking an allowable amount of usage of the portion, and
triggering a lock mode of the portion to limit the one or more functions of the component based on the usage policy to prevent the portion from working, in response to detecting that the amount of usage exceeds the allowable amount of usage and an additional allowable amount of usage of the portion associated with the payment.

21. An apparatus, comprising:
a first module to provide an internal value associated with payment information relating to a computing system,
a second module to prevent a component of the computing system from operating based on a usage policy that selects the component of the computing system, in response to the internal value.

22. The apparatus of claim 21, wherein:
the first module comprises a memory control unit in the computing system to convert the payment information into a data value associate with the payment information, and provide a control signal as the internal value to the second module to indicate that an amount of usage of the computing system exceeds the data value, and
the second module comprises a control circuit that is to assert a logic value to reset the component based on the usage policy in response to the control signal.

23. The apparatus of claim 22, wherein:
the second module executes software in a storing module of the computing system.

24. The apparatus of claim 21, wherein:
the first module comprises a firmware to convert the payment information into the interval value that comprises a data value corresponding to the payment information, and
the second module comprises a control unit embedded a motherboard associated with the computing system, to assert a logic value to prevent the component from operating, in response to determining that usage of a portion of the computing system exceeds the data value and a grace period associated with the payment information expires, the portion being associated with the payment information.

25. The apparatus of claim 21, wherein:
the second control module to prevent the component from operating to prevent the computing system from booting into an operating system associated with the payment information.

26. The apparatus of claim 21, wherein:
the second control module to prevent the component from executing software associated with payment information.

27. The apparatus of claim 21, wherein:
the second control module to prevent one of a processor and hard disc drive of the computing system from operating.
